(19) United States
(12) Patent Application Publication
(10) Pub. No.: US 2025/0349127 A1
(43) Pub. Date: Nov. 13, 2025

(54) VEHICLE CONTROL APPARATUS AND METHOD THEREOF

(71) Applicants: Hyundai Motor Company, Seoul (KR); Kia Corporation, Seoul (KR)

(72) Inventor: Woo Cheol Choi, Hwaseong-Si (KR)

(21) Appl. No.: 18/965,686

(22) Filed: Dec. 2, 2024

(30) Foreign Application Priority Data
May 10, 2024 (KR) 10-2024-0062038

(51) Int. Cl. G06V 20/58; G01S 17/89; G01S 17/931; G06V 10/74; G06V 10/764; G06V 10/82

(52) U.S. Cl. CPC G06V 20/58; G01S 17/89; G01S 17/931; G06V 10/761; G06V 10/764; G06V 10/82

(57) ABSTRACT

A vehicle control apparatus and a method thereof are provided. The vehicle control apparatus includes light detection and ranging (LiDAR) device and a processor. The LiDAR device is configured to obtain sensing information corresponding to a first external object, and a processor. The processor is configured to determine, based on the sensing information, a first virtual box, determine a candidate group including a combination virtual box. The combination virtual box includes the first virtual box and a second virtual box. The processor is further configured to determine, based on applying the LiDAR data to a neural network model, a distribution of the LiDAR points, divide, based on the distribution, the combination virtual box into an adjusted first virtual box and an adjusted second virtual box, and control, based on at least one of the adjusted first virtual box or the adjusted second virtual box, an operation of a vehicle.

### CROSS-REFERENCE TO RELATED APPLICATION

This application claims the benefit of priority to Korean Patent Application No. 10-2024-0062038, filed in the Korean Intellectual Property Office on May 10, 2024, the entire contents of which are incorporated herein by reference.

### TECHNICAL FIELD

The present disclosure relates to a vehicle control apparatus and a method thereof, and more particularly, relates to technologies using light detection and ranging (LiDAR).

### BACKGROUND

Various studies for identifying an external object using various sensors have been in progress to assist with driving of a vehicle.

Particularly, while the vehicle is operating in a driving assist mode or an autonomous driving mode, an external object may be identified using LiDAR.

If the external object is identified by means of the LiDAR, the external object identified by the LiDAR may be identified incorrectly sometimes. Various studies for addressing it have been in progress.

### SUMMARY

The present disclosure has been made to solve the above-mentioned problems occurring in at least some implementations while advantages achieved by those implementations are maintained intact.

An aspect of the present disclosure provides a vehicle control apparatus for accurately identifying a structured object and an unstructured object, using information associated with LiDAR points obtained by LiDAR and a method thereof.

Another aspect of the present disclosure provides a vehicle control apparatus for dividing a combination virtual box in which a virtual box corresponding to a structured object and a virtual box corresponding to an unstructured object are combined with each other, using information associated with LiDAR points obtained by LiDAR and a method thereof.

Another aspect of the present disclosure provides a vehicle control apparatus for accurately separating a structured object and an unstructured object to improve driving stability, if the vehicle operates in a driving assist mode and/or an autonomous driving mode, and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: light detection and ranging (LiDAR) device and a processor. The LiDAR device may be disposed on a vehicle. The LiDAR device may be configured to obtain sensing information corresponding to a first external object. A processor may be configured to: determine, based on the sensing information, a first virtual box corresponding to the first external object; and determine a candidate group including a combination virtual box. The combination virtual box may include the first virtual box and a second virtual box. Determining the candidate group may be based on at least one of: a driving state of the vehicle, a size of the first virtual box, or a position of the first virtual box. The combination virtual box may be associated with LiDAR data representing LiDAR points. The processor may be further configured to: determine, based on applying the LiDAR data to a neural network model, a distribution of the LiDAR points; divide, based on the distribution, the combination virtual box into an adjusted first virtual box and an adjusted second virtual box; and control, based on at least one of the adjusted first virtual box or the adjusted second virtual box, an operation of the vehicle.

The processor may be configured to divide the combination virtual box by: determining the adjusted first virtual box classified as a first type; and determining the adjusted second virtual box classified as a second type different from the first type.

The processor may be further configured to: store, in a grid map, information including a group of LiDAR points that are included in the second virtual box and classified as the second type; and output the stored information.

The processor may be configured to determine the candidate group by: determining the candidate group further based on determining that the first external object corresponds to an external vehicle located within a designated distance from the vehicle in a longitudinal direction of the vehicle.

The processor may be configured to determine the candidate group by: determining the candidate group further based on determining that the first virtual box is located at a designated position in the combination virtual box and further based on a size of the combination virtual box being greater than or equal to a size of the first virtual box by at least a designated proportion.

The processor may be configured to determine the distribution by: determining the distribution further based on projecting the LiDAR points onto a designated surface.

The processor may be further configured to: project the LiDAR points onto the designated surface, based on converting a value associated with a designated axis, among coordinates of the LiDAR points, to a designated value.

The neural network model may include at least one of: a deep learning model or a machine learning model. The machine learning model may include a Gaussian mixture model (GMM).

The processor may be configured to determine the distribution by: determining the distribution based on setting a hyperparameter of the GMM to a designated value.

The first external object may be classified as a first type. The processor may be configured to divide the combination virtual box by: determining a similarity between a characteristic, indicated by a second external object classified as a second type, and the distribution; and determining, based on the similarity, the adjusted first virtual box and the adjusted second virtual box.

The processor may be configured to determine the similarity by: determining the similarity further based on at least one of an x-axis variance of the distribution, a y-axis variance of the distribution, or a Mahalanobis variance of the distribution.

According to one or more example embodiments of the present disclosure, a vehicle control method performed by a vehicle may include: based on information received from a light detection and ranging (LiDAR) device, determining, by a processor of the vehicle, a first virtual box corresponding to a first external object; and determining, by the processor, a candidate group including a combination virtual box. The combination virtual box may include the first virtual box and a second virtual box. Determining the candidate group may be based on at least one of: a driving state of the vehicle, a size of the first virtual box, or a position of the first virtual box. The combination virtual box may be associated with LiDAR data representing LiDAR points. The vehicle control method may further include: determining, by the processor and based on applying the LiDAR data to a neural network model, a distribution of the LiDAR points; dividing, by the processor and based on the distribution, the combination virtual box into an adjusted first virtual box and an adjusted second virtual box; and controlling, based on at least one of the adjusted first virtual box or the adjusted second virtual box, an operation of the vehicle.

Dividing the combination virtual box may include: determining the adjusted first virtual box classified as a first type; and determining the adjusted second virtual box classified as a second type different from the first type.

The vehicle control method may further include: storing, in a grid map, information including a group of LiDAR points that are included in the second virtual box and classified as the second type; and outputting the stored information.

Determining the candidate group may include: determining the candidate group further based on determining that the first external object corresponds to an external vehicle located within a designated distance from the vehicle in a longitudinal direction of the vehicle.

Determining the candidate group may include: determining the candidate group further based on determining that the first virtual box is located at a designated position in the combination virtual box and further based on a size of the combination virtual box being greater than or equal to a size of the first virtual box by at least a designated proportion.

Determining the distribution may include: determining the distribution further based on projecting the LiDAR points onto a designated surface.

The vehicle control method may further include: projecting the LiDAR points onto the designated surface, based on converting a value associated with a designated axis, among coordinates of the LiDAR points, to a designated value.

The neural network model may include at least one of: a deep learning model or a machine learning model. The machine learning model may include a Gaussian mixture model (GMM).

Determining the distribution may include: determining the distribution, based on setting a hyperparameter of the GMM to a designated value.

### BRIEF DESCRIPTION OF THE DRAWINGS

The above and other objects, features and advantages of the present disclosure will be more apparent from the following detailed description taken in conjunction with the accompanying drawings.

FIG. 1 shows an example of a block diagram associated with a vehicle control apparatus;

FIG. 2 shows an example of a flowchart associated with a vehicle control method;

FIG. 3 shows an example of determining a candidate group according to a distance;

FIG. 4 shows an example of determining a candidate group according to a size;

FIG. 5 shows an example of obtaining a GMM-based Gaussian distribution;

FIG. 6 shows an example of log-likelihood;

FIGS. 7A, 7B, and 7C show an example of the result of performing a GMM;

FIG. 8 shows an example of a flowchart associated with a vehicle control method; and

FIG. 9 shows a computing system associated with a vehicle control apparatus or a vehicle control method.

### DETAILED DESCRIPTION

Hereinafter, some aspects of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of one or more example embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., determining first and second virtual boxes) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining first and second virtual boxes) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining first and second virtual boxes) described herein.

Minimum risk maneuver (MRM) operation(s) may also be controlled, for example, based on one or more features (e.g., determining first and second virtual boxes) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., determining first and second virtual boxes) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may include an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining first and second virtual boxes) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

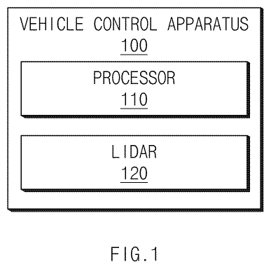

Hereinafter, aspects of the present disclosure will be described in detail with reference to FIGS. 1 to 9.

FIG. 1 shows an example of a block diagram associated with a vehicle control apparatus.

Referring to FIG. 1, a vehicle control apparatus 100 may be implemented inside or outside a vehicle, and some of the components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components which are not shown in FIG. 1.

The vehicle control apparatus 100 may include a processor 110 and LiDAR 120. For example, the processor 110 and the LiDAR 120 may be electronically or operably coupled with each other by an electronical component including a communication bus.

Hereinafter, that pieces of hardware are operably coupled with each other may include that a direct connection or an indirect connection between the pieces of hardware is established in a wired or wireless manner, such that second hardware is controlled by first hardware among the pieces of hardware.

The different blocks are shown, but the present disclosure is not limited thereto. Some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1.

The vehicle control apparatus 100 may include hardware for processing data based on one or more instructions. The hardware for processing the data may include the processor 110.

For example, the hardware for processing the data may include an arithmetic and logic unit (ALU), a floating-point unit (FPU), a field d programmable gate array (FPGA), a central processing unit (CPU), and/or an application processor (AP). The processor 110 may have a structure of a single-core processor or may have a structure of a multi-core processor including a dual core, a quad core, a hexa core, or an octa core.

The LiDAR 120 of the vehicle control apparatus 100 may obtain datasets for identifying a surrounding thing of the vehicle control apparatus 100 (or a vehicle including the vehicle control apparatus 100). For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding object to return.

For example, the LiDAR 120 may obtain a virtual box corresponding to an external object. For example, the virtual box corresponding to the external object may be obtained by LiDAR points obtained by means of the LiDAR 120. For example, the LiDAR 120 may obtain the virtual box corresponding to the external object, based on obtaining a point cloud including a plurality of points, based on the pulse laser signal reflected from the external object.

The processor 110 of the vehicle control apparatus 100 may select a candidate group including a combination virtual box in which a first virtual box corresponding to a first external object and a second virtual box are combined with each other, based on at least one of a driving state of the vehicle, a size of the first virtual box corresponding to the first external object, or a position of the first virtual box corresponding to the first external object, or any combination thereof. For example, the second virtual box may include a virtual box different from the first virtual box. For example, the second virtual box may include a virtual box corresponding to a second external object different from the first external object.

For example, the processor 110 may identify the first external object corresponding to a vehicle located with a designated distance in a longitudinal direction from the vehicle. For example, the processor 110 may determine the candidate group, based on identifying the first external object corresponding to the vehicle located with the designated distance in the longitudinal direction from the vehicle.

For example, the designated distance may include about 80 meters (m). For example, the first external object may fail to correspond to at least one of a pedestrian or a two-wheeled vehicle, or any combination thereof. However, the present disclosure is not limited to that described above.

For example, the processor 110 may determine the candidate group, based on a determination that the first virtual box is located at a designated position in the combination virtual box and the size of the combination virtual box is greater than or equal to the size of the first virtual box by a designated ratio.

For example, the specific position may include both left and right ends of the combination virtual box. For example, the designated ratio may include about 4 times.

For example, the combination virtual box may include a tracking box predicted in a t frame. For example, the combination virtual box may include an undersegmented virtual box. For example, the combination virtual box may include a virtual box in which a structured object and an unstructured object are added.

The processor 110 may input LiDAR data associated with the combination virtual box to a neural network model. For example, the processor 110 may analyze distribution of LiDAR points included in LiDAR data associated with the combination virtual box, based on inputting the LiDAR data to the neural network model.

For example, the processor 110 may analyze the distribution of the LiDAR points included in the LiDAR data associated with the combination virtual box, based on projecting the LiDAR points onto a designated surface.

For example, the designated surface may include an x-y surface. For example, the x-y surface may include a surface formed by an x-axis facing the front of the vehicle and a y-axis parallel to the front surface of the vehicle and perpendicular to the x-axis.

For example, the processor 110 may project the LiDAR points onto the designated surface, based on converting a value expressing a designated axis among coordinates of the LiDAR points to a first designated value.

For example, the designated axis may include a z-axis. For example, the z-axis may include an axis perpendicular to the x-axis and the y-axis. For example, the z-axis may include an axis perpendicular to the x-y surface.

For example, the designated value may include 0.0.

As described above, the processor 110 of the vehicle control apparatus 100 may project the LiDAR points onto the designated surface to obtain LiDAR points with a format such as (m, n, 0).

The processor 110 may analyze the distribution of the LiDAR points included in the LiDAR data associated with the combination virtual box, based on inputting the LiDAR data to the neural network model.

For example, the neural network model may include at least one of a deep learning model or a machine learning model, or any combination thereof.

For example, the machine learning model may include a Gaussian mixture model (GMM).

For example, the processor 110 may set a hyperparameter of the GMM to a second designated value.

For example, the second designated value may include about 2. For example, setting the hyperparameter of the GMM to the second designated value may be represented as “K=2”. For example, the processor 110 may analyze the distribution of the LiDAR points, based on setting the hyperparameter of the GMM to the second designated value.

For example, the processor 110 may compare a characteristic indicated by the external object classified as a second type with the distribution of the LiDAR points, based on the distribution of the LiDAR points.

For example, the processor 110 may separate the first virtual box and the second virtual box, based on a similarity between the distribution of the LiDAR points s and the characteristic indicated by the external object classified as the second type.

For example, the processor 110 may identify the similarity between the distribution of the LiDAR points and the characteristic indicated by the external object classified as the second type, based on at least one of x-axis variance for the distribution of the LiDAR points, y-axis variance for the distribution of the LiDAR points, or Mahalanobis variance for the distribution of the LiDAR points, or any combination thereof.

The processor 110 may divide the combination virtual box into the first virtual box (also referred to as an adjusted first virtual box) and the second virtual box (also referred to as an adjusted second virtual box), based on the distribution of the LiDAR points. For example, the processor 110 may divide the combination virtual box into the first virtual box and the second virtual box, based on the distribution of the LiDAR points, to output at least one of the first virtual box or the second virtual box, or any combination thereof.

For example, the processor 110 may separate the first virtual box classified as a first type and the second virtual box classified as the second type different from the first type. For example, the processor 110 may separate the first virtual box classified as the first type and the second virtual box classified as the second type to output at least one of the first virtual box or the second virtual box, or any combination thereof.

For example, the first type may indicate a structured object. For example, the second type may indicate an unstructured object.

For example, the combination virtual box may be represented as a third type. For example, the third type may indicate a type in which the first type and the second type are combined with each other. For example, the third type may indicate that the structured object and the unstructured object are combined with each other.

For example, the processor 110 may store information including LiDAR points forming the second virtual box classified as the second type in a grid map. For example, the processor 110 may output the information stored in the grid map.

The processor 110 may divide the combination virtual box into the first virtual box (e.g., an adjusted first virtual box) and the second virtual box (e.g., an adjusted second virtual box), based on the distribution of the LiDAR points, to output at least one of the first virtual box or the second virtual box, or any combination thereof.

The processor 110 may control the vehicle, based on outputting the at least one of the first virtual box or the second virtual box, or the any combination thereof. For example, the processor 110 may set a route for avoiding an obstacle, in a driving assist mode of the vehicle and/or an autonomous driving mode of the vehicle, based on outputting the at least one of the first virtual box or the second virtual box, or the any combination thereof, thus controlling the vehicle.

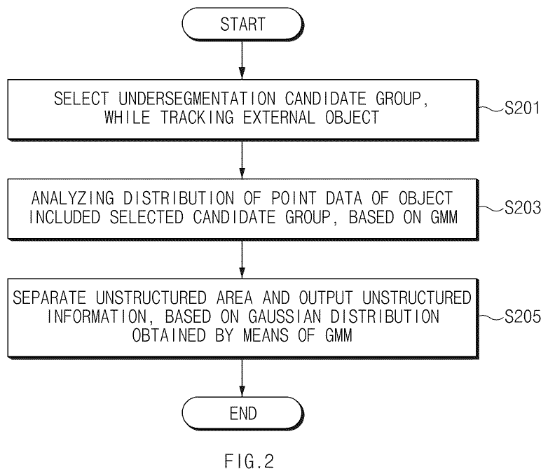

FIG. 2 shows an example of a flowchart associated with a vehicle control method.

Hereinafter, it is assumed that a vehicle control apparatus 100 of FIG. 1 performs a process of FIG. 2. Furthermore, in a description of FIG. 2, an operation described as being performed by an apparatus may be understood as being controlled by a processor 110 of the vehicle control apparatus 100.

At least one of the operations of FIG. 2 may be performed by the vehicle control apparatus 100 of FIG. 1. At least one of the operations of FIG. 2 may be controlled by the processor 110 of FIG. 1. The respective operations of FIG. 2 may be sequentially performed, but are not necessarily sequentially performed. For example, an order of the respective operations may be changed, and at least two operations may be performed in parallel.

Referring to FIG. 2, in S201, the vehicle control method may include selecting an under segmentation candidate group, while tracking an external object.

For example, the vehicle control method may include selecting a driving situation of a vehicle and a moving object condition.

For example, the vehicle control method may include selecting a moving object meeting a first condition and a second condition.

For example, the first condition may be associated with whether the moving object is an object corresponding to a vehicle rather than a pedestrian or a two-wheeled vehicle. For example, meeting the first condition may include that the moving object is the object corresponding to the vehicle rather than the pedestrian or the two-wheeled vehicle. For example, not meeting the first condition may include that the moving object is an object corresponding to the pedestrian and/or the two-wheeled vehicle.

For example, the second condition may be associated with whether the object is a vehicle located within 80 m in a longitudinal direction of the vehicle. For example, meeting the second condition may include that the object is located within 80 m in the longitudinal direction of the vehicle. For example, not meeting the second condition may include that the object is located out of 80 m in the longitudinal direction of the vehicle.

For example, the vehicle control method may include selecting a candidate by means of a size of a virtual box and a tracking prediction value.

For example, the vehicle control method may include selecting a corresponding virtual box as a candidate, if it fails to track a tracking box predicted in a t frame compared to a t−1 frame and there is the corresponding virtual box at the left or right end in the undersegmented box.

For example, the vehicle control method may include selecting the corresponding virtual box as the candidate, based on that the size of a virtual box with an identifier of an existing tracking object increases by 4 times or more.

In S203, the vehicle control method may include analyzing distribution of point data of an object included the selected candidate group, based on a GMM.

For example, the vehicle control method may include projecting point data of a candidate object onto an x-y surface.

Because it is difficult to perform a GMM analysis in real time because it takes a long time to perform the GMM analysis in a three-dimensional (3D) space coordinate system, the vehicle control method may include projecting the point data of the candidate object onto the x-y surface.

For example, the vehicle control method may include proceeding with analyzing distribution of GMM-based point data.

For example, the vehicle control method may include dividing the point data projected onto the x-y surface into K distributions in one cluster. For example, K may include a hyperparameter of the GMM.

For example, the vehicle control method may include initializing a GMM parameter. For example, the GMM parameter may include at least one of a mixture model number or max iter (e.g., iteration), or any combination thereof.

For example, the vehicle control method may include sequentially performing an E-step and an M-step. For example, the E-step may include an expectation-step. For example, the M-step may include a maximization-step.

For example, the vehicle control method may include predicting a posterior distribution based on a current parameter, in the E-step. For example, the vehicle control method may include identifying the entire log-likelihood expected value for some parameters.

For example, the vehicle control method may include calculating p (Z|X, Θ^{old}) for the current distribution, based on the parameter, Gold, for the current distribution, in the E-step.

For example, the vehicle control method may include selecting distribution in which a log-likelihood for a new posterior distribution is maximized, in the M-step.

For example, the vehicle control method may include selecting distribution in which a log-likelihood for predicted K Gaussian distributions, which correspond to calculated current K Gaussian distributions, is maximized, in the E-step.

For example, the vehicle control method may include performing Θ^{new}=argmax_ΘQ (Θ, Θ^{old}) to select the distribution in which the log-likelihood for the predicted K Gaussian distributions is maximized.

For example, the vehicle control method may include selecting the distribution in which the log-likelihood is maximized, in the process of repeating the above-mentioned E-step and M-step a preset maximum repeated number of times, N times.

For example, the vehicle control method may include performing the above-mentioned operations to identify at least one of a virtual box with an L-shape or a virtual box with an I-shape, or any combination thereof.

In S205, the vehicle control method may include separating an unstructured area and outputting unstructured information, based on the Gaussian distribution obtained by means of the GMM.

For example, the vehicle control method may include separating the unstructured area according to the GMM distribution.

For example, the unstructured area may include the second virtual box described with reference to FIG. 1.

For example, the vehicle control method may include storing a point of an unstructured object in a grid map and outputting information.

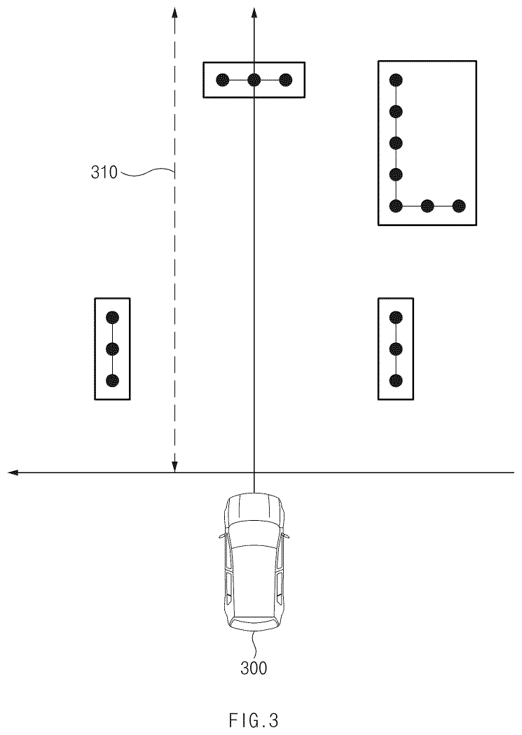

FIG. 3 shows an example of determining a candidate group according to a distance.

Referring to FIG. 3, a vehicle control apparatus (e.g., a vehicle control apparatus 100 of FIG. 1) may be included in a vehicle 300. For example, a processor (e.g., a processor 110 of FIG. 1) of the vehicle control apparatus may determine a candidate group, based on LiDAR data obtained by means of LiDAR (e.g., LiDAR 120 of FIG. 1).

For example, the processor may determine a virtual box corresponding to a vehicle located within a designated distance 310 in a longitudinal direction of the vehicle 300 from the vehicle 300 as the candidate group.

For example, the longitudinal direction of the vehicle 300 may include the same direction as the progress direction of the vehicle 300. For example, the longitudinal direction of the vehicle 300 may include a direction which is perpendicular to the front of the vehicle 300 and is parallel to the ground.

For example, the longitudinal direction of the vehicle 300 may include the same direction as a positive direction of the x-axis described with reference to FIG. 1.

For example, the processor may determine a moving object corresponding to a vehicle rather than a pedestrian or a two-wheeled vehicle, which is identified within the designated distance 310 in the longitudinal direction of the vehicle 300 from the vehicle 300, as the candidate group.

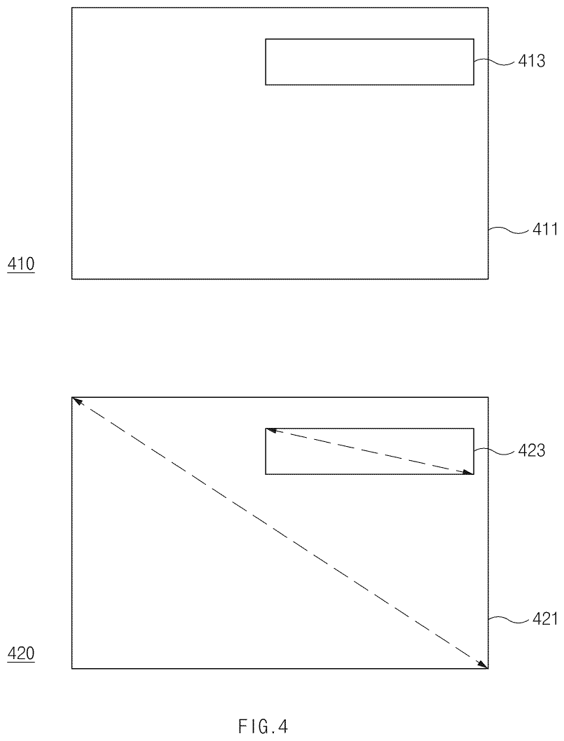

FIG. 4 shows an example of determining a candidate group according to a size.

Referring to FIG. 4, a processor (e.g., a processor 110 of FIG. 1) of a vehicle control apparatus (e.g., a vehicle control apparatus 100 of FIG. 1) may identify a size of a virtual box obtained by LiDAR (e.g., LiDAR 120 of FIG. 1).

In a first example 410, the processor may determine a position of a virtual box 413 included in a combination virtual box 411.

For example, the processor may determine whether the virtual box 413 included in the combination virtual box 411 is located at an end in a left or right direction of the combination virtual box 411.

For example, the processor may perform an operation of identifying whether the virtual box 413 is located within a threshold distance from a left segment (or a left surface) of the combination virtual box 411. For example, the processor may perform an operation of identifying whether the virtual box 413 is located within the threshold distance from a right segment (or a right surface) of the combination virtual box 411.

For example, the processor may perform an operation of identifying whether the virtual box 413 is located within the threshold distance from one of segments (or surfaces) at both ends of the combination virtual box 411.

For example, the processor may perform an operation of determining the combination virtual box 411 including the virtual box 413 located within the threshold distance from a segment of the combination virtual box 411 as the candidate group, based on that the virtual box 413 is located within the threshold distance from the segment of the combination virtual box 411.

In a second example 420, the processor may compare a size of a combination virtual box 421 with a size of a virtual box 423.

For example, the processor may perform an operation of identifying a diagonal length of the combination virtual box 421. For example, the processor may perform an operation of identifying a diagonal length of the virtual box 423.

For example, the combination virtual box 421 shown in the second example 420 may be a combination virtual box identified in a t frame and may include a virtual box with the same identifier as an identifier of the virtual box 423 in a t−1 frame. As the identifier of the combination virtual box 421 identified in the t frame is the same as the identifier of the virtual box 423 in the t−1 frame, the identifier of the virtual box 423 in the t frame may be different from the identifier in the t−1 frame.

For example, the processor may determine the combination virtual box 421 as the candidate group, based on that the size of the combination virtual box 421 with the above identifier is greater than or equal to the size of the virtual box 423 by at least a designated ratio or proportion (e.g., about 4 times).

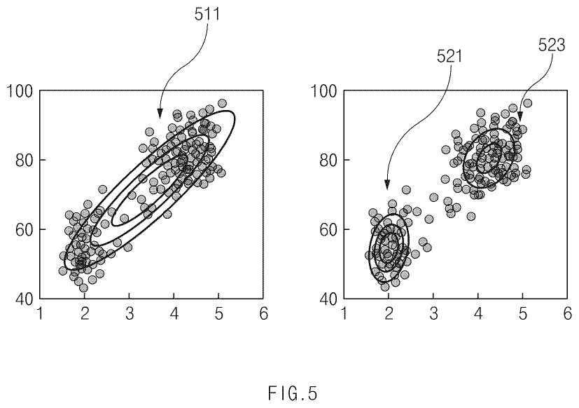

FIG. 5 shows an example of obtaining a GMM-based Gaussian distribution.

Referring to FIG. 5, a processor (e.g., a processor 110 of FIG. 1) of a vehicle control apparatus (e.g., a vehicle control apparatus 100 of FIG. 1) may obtain a GMM-based Gaussian distribution.

A first example 510 of FIG. 5 may include an example of a single Gaussian distribution 511.

A second example 520 of FIG. 5 may include a mixture of two Gaussian.

Referring to the first example 510, to obtain the single Gaussian distribution 511, the processor may set a hyperparameter of a GMM to “1”. For example, the processor may set “K=1” to obtain the single Gaussian distribution 511.

Referring to the second example 520, to obtain a mixed Gaussian distribution, the processor may set the hyperparameter of the GMM to “2”. For example, the processor may set “K=2” to obtain the mixed Gaussian distribution.

For example, to separate undersegmentation of an unstructured object and a structured object, the processor may set “K=2” to obtain a graph including a plurality of distributions 521 and 523 like the second example 520.

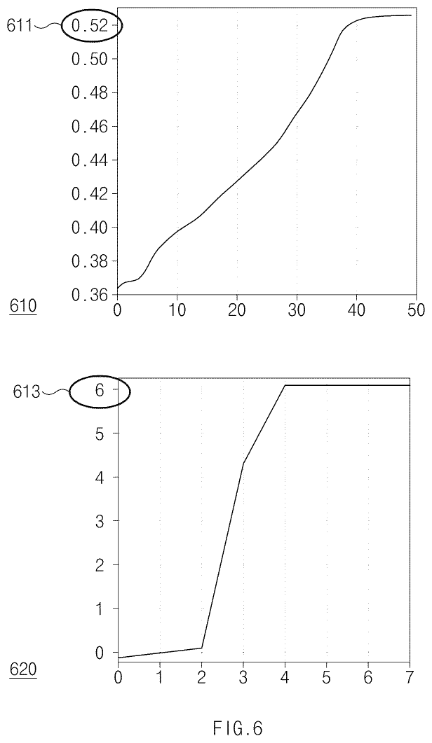

FIG. 6 shows an example of log-likelihood.

Referring to FIG. 6, a first graph 610 and/or a second graph 620 may include a graph indicating a log-likelihood. For example, the graph indicating the log-likelihood may be obtained by a processor (e.g., a processor 110 of FIG. 1).

For example, the first graph 610 may include a graph illustrating that the E-step and the M-step, which are described above, are performed n times.

For example, the second graph 620 may include a graph illustrating that the E-step and the M-step, which are described above, are performed a number of times greater than the n times.

Seeing the first graph 610 and the second graph 620, it may be checked that a second maximum value 613 of the second graph 620 is relatively greater than a first maximum value 611 of the first graph 610.

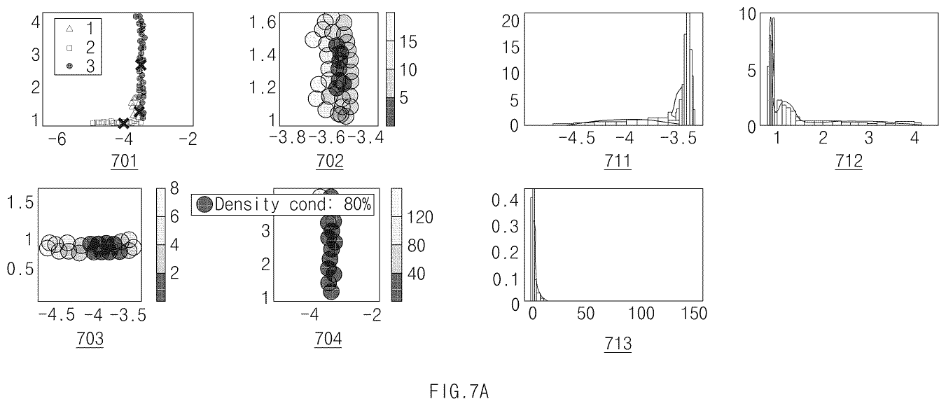

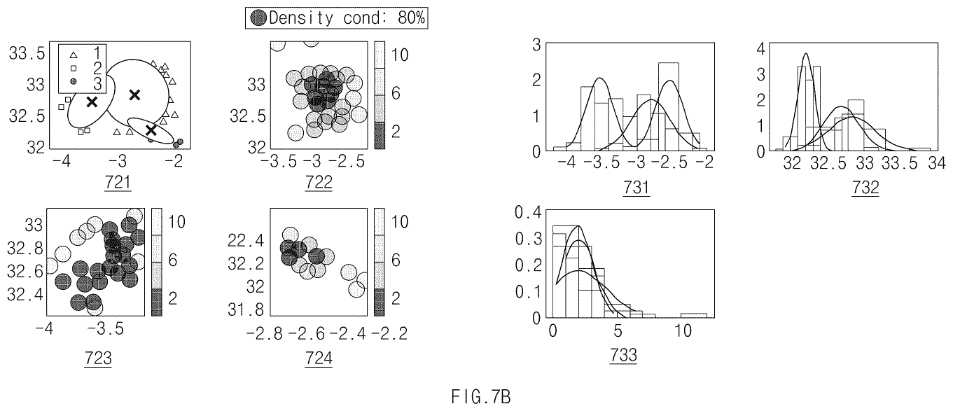

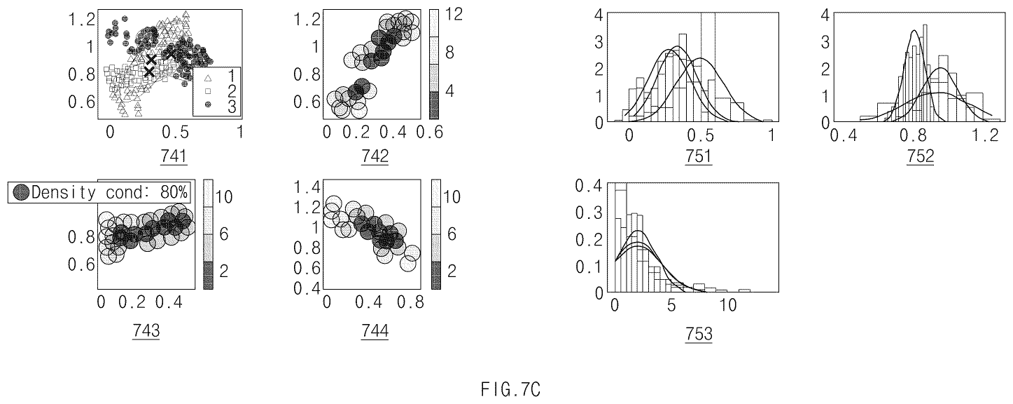

FIGS. 7A to 7C show an example of the result of performing a GMM.

Referring to FIG. 7A, a processor (e.g., a processor 110 of FIG. 1) of a vehicle control apparatus (e.g., a vehicle control apparatus 100 of FIG. 1) may obtain distributed models 702, 703, and 704, based on inputting point data 701 to a GMM. For example, the point data 701 may include points generated by a structured object including a vehicle.

For example, the processor may obtain x-axis variance 711, y-axis variance 712, and/or Mahalanobis variance 713 of the distributed models 702, 703, and 704.

The distributed models 702, 703, and 704 of FIG. 7A may include a distributed model obtained from the structured object including the vehicle.

For example, characteristics of the distributed models 702, 703, and 704 of FIG. 7A may include i) low variance, ii) dense mixture model, and/or iii) dense Mahalanobis distance.

Referring to FIG. 7B, the processor may obtain distributed models 722, 723, and 724, based on inputting point data 721 to the GMM. For example, the point data 721 may include points generated by an unstructured object including a bush.

For example, the processor may obtain x-axis variance 731, y-axis variance 732, and/or Mahalanobis variance 733 of the distributed models 722, 723, and 724.

Referring to FIG. 7C, the processor may obtain distributed models 742, 743, and 744, based on inputting point data 741 to the GMM. For example, the point data 741 may include points generated by an unstructured object including dust.

For example, the processor may obtain x-axis variance 751, y-axis variance 752, and/or Mahalanobis variance 753 of the distributed models 742, 743, and 744.

For example, characteristics of the distributed models 722, 723, and 724 of FIG. 7B and/or the distributed models 742, 743, and 744 of 7C may include i) high variance, ii) sparse mixture model, and/or iii) sparse Mahalanobis distance.

The examples of FIGS. 7A to 7C are an example for convenience of description, and the present disclosure is not limited to that described above.

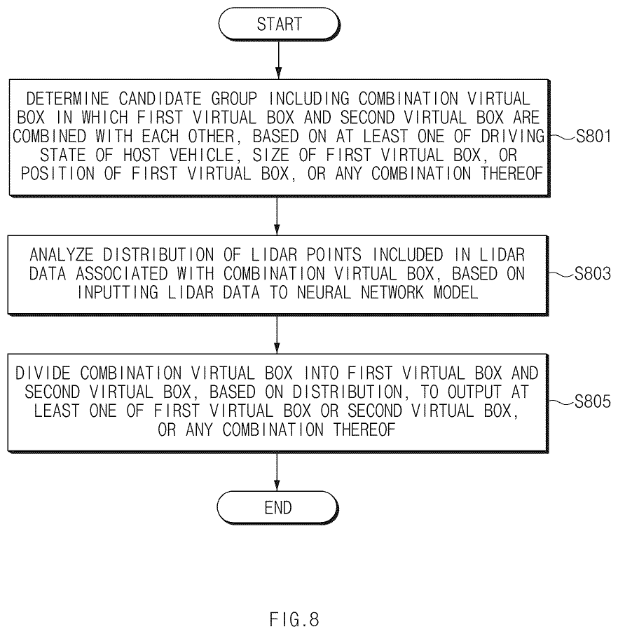

FIG. 8 shows an example of a flowchart associated with a vehicle control method.

Hereinafter, it is assumed that a vehicle control apparatus 100 of FIG. 1 performs a process of FIG. 8. Furthermore, in a description of FIG. 8, an operation described as being performed by an apparatus may be understood as being controlled by a processor 110 of the vehicle control apparatus 100.

At least one of the operations of FIG. 8 may be performed by the vehicle control apparatus 100 of FIG. 1. At least one of the operations of FIG. 8 may be controlled by the processor 110 of FIG. 1. The respective operations of FIG. 8 may be sequentially performed, but are not necessarily sequentially performed. For example, an order of the respective operations may be changed, and at least two operations may be performed in parallel.

Referring to FIG. 8, in S801, the vehicle control method may include determining a candidate group including a combination virtual box in which a first virtual box and a second virtual box are combined with each other, based on at least one of a driving state of a vehicle, a size of the first virtual box, or a position of the first virtual box, or any combination thereof.

For example, the vehicle control method may include determining the candidate group, based on identifying a first external object corresponding to a vehicle located within a designated distance in a longitudinal direction of the vehicle from the vehicle.

For example, the vehicle control method may include determining the candidate group, based on that there is the first virtual box at a designated position in the combination virtual box and the size of the combination virtual box is greater than or equal to the size of the first virtual box by a designated ratio.

In S803, the vehicle control method may include analyzing distribution of LiDAR points included in LiDAR data associated with the combination virtual box, based on inputting the LiDAR data to a neural network model.

For example, the vehicle control method may include analyzing the distribution of the LiDAR points, based on projecting the LiDAR points onto a designated surface.

For example, the vehicle control method may include projecting the LiDAR points onto the designated surface, based on converting a value expressing (e.g., associated with) a designated axis among coordinates of the LiDAR points to a first designated value.

For example, the neural network model may include at least one of a deep learning model or a machine learning model, or any combination thereof. For example, the machine learning model may include a Gaussian mixture model (GMM).

For example, the vehicle control method may include analyzing the distribution of the LiDAR points, based on setting a hyperparameter of the GMM to a second designated value.

For example, the vehicle control method may include comparing a characteristic indicated by an external object classified as a second type with the distribution of the LiDAR points, based on the distribution of the LiDAR points. For example, the vehicle control method may include separating the first virtual box and the second virtual box, based on a similarity between the distribution of the LiDAR points s and the characteristic indicated by the external object classified as the second type.

For example, the vehicle control method may include identifying the similarity between the distribution of the LiDAR points and the characteristic indicated by the external object classified as the second type, based on at least one of x-axis variance for the distribution of the LiDAR points, y-axis variance for the distribution of the LiDAR points, or Mahalanobis variance for the distribution of the LiDAR points, or any combination thereof.

In S805, the vehicle control method may include dividing the combination virtual box into the first virtual box (e.g., an adjusted first virtual box) and the second virtual box (e.g., an adjusted second virtual box), based on the distribution of the LiDAR points, to output at least one of the first virtual box or the second virtual box, or any combination thereof.

For example, the vehicle control method may include separating the first virtual box classified as a first type and the second virtual box classified as the second type different from the first type to output the at least one of the first virtual box or the second virtual box, or the any combination thereof.

For example, the vehicle control method may include storing information including LiDAR points forming the second virtual box classified as the second type in a grid map. The vehicle control method may include outputting the information stored in the grid map.

For example, the vehicle control method may include dividing the combination virtual box into the first virtual box (e.g., an adjusted first virtual box) and the second virtual box (e.g., an adjusted second virtual box) to control an operation of the vehicle.

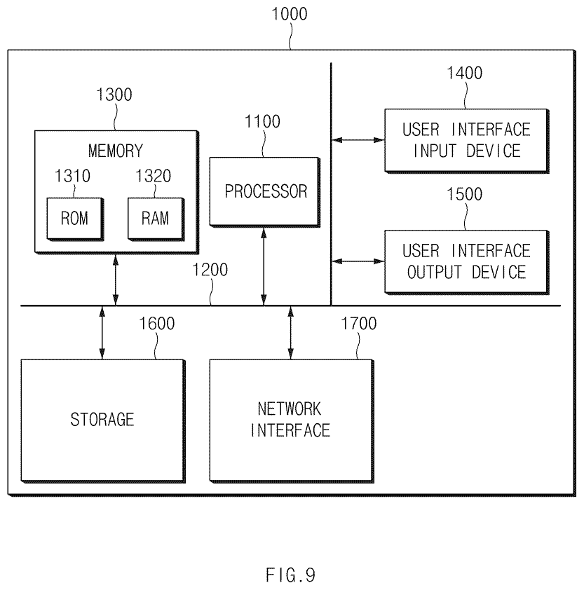

FIG. 9 shows a computing system associated with a vehicle control apparatus or a vehicle control method.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random-access memory (RAM) 1320.

Accordingly, the operations of the method or algorithm described herein may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, a vehicle control apparatus may include light detection and ranging (LiDAR) that obtains a first virtual box corresponding to a first external object and a processor. The processor may determine a candidate group including a combination virtual box in which the first virtual box and a second virtual box are combined with each other, based on at least one of a driving state of a vehicle, a size of the first virtual box, or a position of the first virtual box, or any combination thereof, may analyze distribution of LiDAR points included in LiDAR data associated with the combination virtual box, based on inputting the LiDAR data to a neural network model, and may divide the combination virtual box into the first virtual box and the second virtual box, based on the distribution, to output at least one of the first virtual box or the second virtual box, or any combination thereof.

The processor may separate the first virtual box classified as a first type and the second virtual box classified as a second type different from the first type to output the at least one of the first virtual box or the second virtual box, or the any combination thereof.

The processor may store information including LiDAR points forming the second virtual box classified as the second type in a grid map and may output the stored information.

The processor may determine the candidate group, based on identifying the first external object corresponding to a vehicle located within a designated distance in a longitudinal direction of the vehicle from the vehicle.

The processor may determine the candidate group, based on that there is the first virtual box at a designated position in the combination virtual box and a size of the combination virtual box is greater than or equal to a size of the first virtual box by a designated ratio.

The processor may analyze the distribution, based on projecting the LiDAR points onto a designated surface.

The neural network model may include at least one of a deep learning model or a machine learning model, or any combination thereof. The machine learning model may include a Gaussian mixture model (GMM).

The processor may compare a characteristic indicated by an external object classified as a second type with the distribution, based on the distribution, and may separate the first virtual box and the second virtual box, based on a similarity between the distribution and the characteristic.

The processor may identify the similarity, based on at least one of x-axis variance for the distribution, y-axis variance for the distribution, or Mahalanobis variance for the distribution, or any combination thereof.

According to another aspect of the present disclosure, a vehicle control method may include determining, by a processor, a candidate group including a combination virtual box in which a first virtual box corresponding to a first external object and a second virtual box are combined with each other, based on at least one of a driving state of a vehicle, a size of the first virtual box, or a position of the first virtual box, or any combination thereof, analyzing, by the processor, distribution of LiDAR points included in LiDAR data associated with the combination virtual box, based on inputting the LiDAR data to a neural network model, and dividing, by the processor, the combination virtual box into the first virtual box and the second virtual box, based on the distribution, to output at least one of the first virtual box or the second virtual box, or any combination thereof.

The vehicle control method may further include separating the first virtual box classified as a first type and the second virtual box classified as a second type different from the first type to output the at least one of the first virtual box or the second virtual box, or the any combination thereof.

The vehicle control method may further include storing information including LiDAR points forming the second virtual box classified as the second type in a grid map and outputting the stored information.

The vehicle control method may further include determining the candidate group, based on identifying the first external object corresponding to a vehicle located within a designated distance in a longitudinal direction of the vehicle from the vehicle.

The vehicle control method may further include determining the candidate group, based on that there is the first virtual box at a designated position in the combination virtual box and a size of the combination virtual box is greater than or equal to a size of the first virtual box by a designated ratio.

The vehicle control method may further include analyzing the distribution, based on projecting the LiDAR points onto a designated surface.

The vehicle control method may further include projecting the LiDAR points onto the designated surface, based on converting a value expressing a designated axis among coordinates of the LiDAR points to a first designated value.

The neural network model may include at least one of a deep learning model or a machine learning model, or any combination thereof. The machine learning model may include a Gaussian mixture model (GMM).

The vehicle control method may further include analyzing the distribution, based on setting a hyperparameter of the GMM to a second designated value.

The present technology may accurately identify a structured object and an unstructured object, using information associated with LiDAR points obtained by the LiDAR.

Furthermore, the present technology may divide a combination virtual box in which a virtual box corresponding to the structured object and a virtual box corresponding to the unstructured object are combined with each other, using the information associated with the LiDAR points obtained by the LiDAR.

Furthermore, the present technology may accurately separate the structured object and the unstructured object to improve driving stability, if the vehicle operates in a driving assist mode and/or an autonomous driving mode.

In addition, various effects ascertained directly or indirectly through the present disclosure may be provided.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the examples of the present described disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus comprising:
light detection and ranging (LiDAR) device disposed on a vehicle, wherein the LiDAR device is configured to obtain sensing information corresponding to a first external object; and
a processor configured to:
determine, based on the sensing information, a first virtual box corresponding to the first external object;
determine a candidate group comprising a combination virtual box, wherein the combination virtual box comprises the first virtual box and a second virtual box, wherein the determining of the candidate group is based on at least one of: a driving state of the vehicle, a size of the first virtual box, or a position of the first virtual box, and wherein the combination virtual box is associated with LiDAR data representing LiDAR points;
determine, based on applying the LiDAR data to a neural network model, a distribution of the LiDAR points;
divide, based on the distribution, the combination virtual box into an adjusted first virtual box and an adjusted second virtual box; and
control, based on at least one of the adjusted first virtual box or the adjusted second virtual box, an operation of the vehicle.

2. The vehicle control apparatus of claim 1, wherein the processor is configured to divide the combination virtual box by:
determining the adjusted first virtual box classified as a first type; and
determining the adjusted second virtual box classified as a second type different from the first type.

3. The vehicle control apparatus of claim 2, wherein the processor is further configured to:
store, in a grid map, information comprising a group of LiDAR points that are included in the second virtual box and classified as the second type; and
output the stored information.

4. The vehicle control apparatus of claim 1, wherein the processor is configured to determine the candidate group by:
determining the candidate group further based on determining that the first external object corresponds to an external vehicle located within a designated distance from the vehicle in a longitudinal direction of the vehicle.

5. The vehicle control apparatus of claim 1, wherein the processor is configured to determine the candidate group by:
determining the candidate group further based on determining that the first virtual box is located at a designated position in the combination virtual box and further based on a size of the combination virtual box being greater than or equal to a size of the first virtual box by at least a designated proportion.

6. The vehicle control apparatus of claim 1, wherein the processor is configured to determine the distribution by:
determining the distribution further based on projecting the LiDAR points onto a designated surface.

7. The vehicle control apparatus of claim 6, wherein the processor is further configured to:
project the LiDAR points onto the designated surface, based on converting a value associated with a designated axis, among coordinates of the LiDAR points, to a designated value.

8. The vehicle control apparatus of claim 1, wherein the neural network model comprises at least one of: a deep learning model or a machine learning model, and
wherein the machine learning model comprises a Gaussian mixture model (GMM).

9. The vehicle control apparatus of claim 8, wherein the processor is configured to determine the distribution by:
determining the distribution based on setting a hyperparameter of the GMM to a designated value.

10. The vehicle control apparatus of claim 1, wherein the first external object is classified as a first type, and wherein the processor is configured to divide the combination virtual box by:
determining a similarity between a characteristic, indicated by a second external object classified as a second type, and the distribution; and
determining, based on the similarity, the adjusted first virtual box and the adjusted second virtual box.

11. The vehicle control apparatus of claim 10, wherein the processor is configured to determine the similarity by:
determining the similarity further based on at least one of an x-axis variance of the distribution, a y-axis variance of the distribution, or a Mahalanobis variance of the distribution.

12. A vehicle control method performed by a vehicle, the vehicle control method comprising:
based on information received from a light detection and ranging (LiDAR) device, determining, by a processor of the vehicle, a first virtual box corresponding to a first external object;
determining, by the processor, a candidate group comprising a combination virtual box, wherein the combination virtual box comprises the first virtual box and a second virtual box, wherein the determining of the candidate group is based on at least one of: a driving state of the vehicle, a size of the first virtual box, or a position of the first virtual box, and wherein the combination virtual box is associated with LiDAR data representing LiDAR points;
determining, by the processor and based on applying the LiDAR data to a neural network model, a distribution of the LiDAR points;
dividing, by the processor and based on the distribution, the combination virtual box into an adjusted first virtual box and an adjusted second virtual box; and
controlling, based on at least one of the adjusted first virtual box or the adjusted second virtual box, an operation of the vehicle.

13. The vehicle control method of claim 12, wherein the dividing of the combination virtual box comprises:
determining the adjusted first virtual box classified as a first type; and
determining the adjusted second virtual box classified as a second type different from the first type.

14. The vehicle control method of claim 13, further comprising:
storing, in a grid map, information comprising a group of LiDAR points that are included in the second virtual box and classified as the second type; and
outputting the stored information.

15. The vehicle control method of claim 12, wherein the determining of the candidate group comprises:
determining the candidate group further based on determining that the first external object corresponds to an external vehicle located within a designated distance from the vehicle in a longitudinal direction of the vehicle.

16. The vehicle control method of claim 12, wherein the determining of the candidate group comprises:
determining the candidate group further based on determining that the first virtual box is located at a designated position in the combination virtual box and further based on a size of the combination virtual box being greater than or equal to a size of the first virtual box by at least a designated proportion.

17. The vehicle control method of claim 12, wherein the determining of the distribution comprises:
determining the distribution further based on projecting the LiDAR points onto a designated surface.

18. The vehicle control method of claim 17, further comprising:
projecting the LiDAR points onto the designated surface, based on converting a value associated with a designated axis, among coordinates of the LiDAR points, to a designated value.

19. The vehicle control method of claim 12, wherein the neural network model comprises at least one of: a deep learning model or a machine learning model, and
wherein the machine learning model comprises a Gaussian mixture model (GMM).

20. The vehicle control method of claim 19, wherein the determining of the distribution comprises:
determining the distribution, based on setting a hyperparameter of the GMM to a designated value.
